(19) United States
(12) Patent Application Publication
(10) Pub. No.: US 2025/0342115 A1
(43) Pub. Date: Nov. 6, 2025

(54) TECHNIQUES FOR MANAGING SOLID-STATE STORAGE DEVICES

(71) Applicant: Apple Inc., Cupertino, CA (US)

(72) Inventors: Andrew W. VOGAN, Austin, TX (US); Alexander PALEY, San Jose, CA (US); Muhammad N. ASHRAF, San Jose, CA (US); Tudor ANTONIU, Woodland, CA (US); Yuhua LIU, Belmont, CA (US); Max ANTELL, San Mateo, CA (US)

(21) Appl. No.: 19/174,467

(22) Filed: Apr. 9, 2025

Related U.S. Application Data
(60) Provisional application No. 63/642,556, filed on May 3, 2024.

(51) Int. Cl. G06F 12/02

(52) U.S. Cl. CPC G06F 12/0246

(57) ABSTRACT

Disclosed herein are techniques for managing write amplification on a storage device. According to some embodiments, the method can be implemented by a computing device that is communicatively coupled to the storage device, and includes the steps of (1) receiving a request to write data to the storage device, (2) identifying that the storage device is experiencing a particular level of write amplification among a plurality of levels of write amplification, (3) generating, within the storage device, at least one band having a respective width that corresponds to the particular level of write amplification, and (4) writing the data into the at least one band.

### CROSS-REFERENCE TO RELATED APPLICATIONS

The present application claims the benefit of U.S. Provisional Application No. 63/642,556, entitled “TECHNIQUES FOR MANAGING SOLID-STATE STORAGE DEVICES,” filed May 3, 2024, the content of which is incorporated by reference herein in its entirety for all purposes.

### FIELD

The disclosure relates to managing solid-state storage devices (SSDs) and, more particularly, to techniques for mitigating write amplification in SSDs, managing data transfers between different types of SSDs (e.g., single-level cell (SLC) to triple-level cell (TLC) SSDs), and managing storage space availability in SSDs under load conditions.

### BACKGROUND

Solid state drives (SSDs) are a type of mass storage device that share a similar footprint with (and provide similar functionality as) traditional magnetic-based hard disk drives (HDDs). Notably, standard SSDs-which utilize “flash” memory-can provide various advantages over standard HDDs, such as considerably faster Input/Output (I/O) performance. For example, average I/O latency speeds provided by SSDs typically outperform those of HDDs because the I/O latency speeds of SSDs are less-affected when data is fragmented across the memory sectors of SSDs. This occurs because HDDs include a read head component that must be relocated each time data is read/written, which produces a latency bottleneck as the average contiguity of written data is reduced over time. Moreover, when fragmentation occurs within HDDs, it becomes necessary to perform resource-expensive defragmentation operations to improve or restore performance. In contrast, SSDs, which are not bridled by read head components, can largely maintain I/O performance even as data fragmentation levels increase. SSDs also provide the benefit of increased impact tolerance (as there are no moving parts), and, in general, virtually limitless form factor potential. These advantages—combined with the increased availability of SSDs at consumer-affordable prices—make SSDs a preferable choice for mobile devices such as laptops, tablets, and smart phones.

Despite the foregoing benefits provided by SSDs, some drawbacks remain that have yet to be addressed, including issues that arise under write amplification scenarios. Write amplification refers to the phenomenon in SSDs where the amount of data actually written to the storage medium exceeds the amount intended to be written by the host system. This can occur due to the nature of NAND flash memory and the mechanisms employed by SSDs for data management, such as wear leveling, garbage collection, and over-provisioning. In particular, these processes can involve moving, erasing, and rewriting data at the block level, which often leads to additional write operations beyond those initiated by the host. Write amplification can therefore negatively impact SSD performance, endurance, and overall efficiency, as it increases the wear on the NAND cells and consumes more of the limited write/erase cycles available.

### SUMMARY

The described apsects set forth techniques for managing solid-state storage devices (SSDs). In particular, the embodiments set forth techniques for mitigating write amplification in SSDs, managing data transfers between different types of SSDs (e.g., single-level cell (SLC) to triple-level cell (TLC) SSDs), and managing storage space availability in SSDs under load conditions.

One aspect sets forth a method for managing write amplification on a storage device. According to some aspects, the method can be implemented by a computing device that is communicatively coupled to the storage device, and includes the steps of receiving a request to write data to the storage device, identifying that the storage device is experiencing a particular level of write amplification among a plurality of levels of write amplification, generating, within the storage device, at least one band having a respective width that corresponds to the particular level of write amplification, and writing the data into the at least one band.

Another aspect sets forth a method for managing transfers between a first storage device and a second storage device. According to some aspects, the method can be implemented by a computing device that is communicatively coupled to the first and second storage devices, and includes the steps of receiving a request to write data from the first storage device to the second storage device, generating, within the second storage device, at least one first band having a respective first width that is based at least in part on a size of the data, generating, within the second storage device, at least one second band having a respective second width that complements the respective first width of the at least one first band and a hardware characteristic of the second storage device, and writing the data into the at least one first band.

Yet another aspect sets forth a method for managing storage space availability in a storage device. According to some aspects, the method can be implemented by a computing device that is communicatively coupled to the storage device, and includes the steps of receiving a request to write data to the storage device, determining a number of available bands in the storage device, determining that the number of available bands is unsatisfactory for enabling the data to be written to the storage device, determining a number of garbage collection operations needed to cause the number of available bands to be satisfactory for enabling the data to be written to the storage device, establishing a ratio based on the number of available bands and the number of garbage collection operations, and causing write operations associated with the data to be performed in conjunction with the garbage collection operations, wherein the write operations are performed at a reduced rate that is based on the ratio.

Other aspects include a non-transitory computer readable storage medium configured to store instructions that, when executed by a processor included in a computing device, cause the computing device to carry out the various steps of any of the foregoing methods. Further aspects include a computing device that is configured to carry out the various steps of any of the foregoing methods.

Other aspects and advantages described herein will become apparent from the following detailed description taken in conjunction with the accompanying drawings which illustrate, by way of example, the principles of the described aspects.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIGS. 1A-1B illustrate block diagrams of different components of a computing device that can be configured to implement the various techniques described herein, according to some embodiments.

FIGS. 2A-2D illustrate conceptual diagrams of different approaches for managing dynamic-width bands, according to some embodiments.

FIG. 2E illustrates a method for managing write amplification on a storage device, according to some embodiments.

FIGS. 3A-3C illustrate conceptual diagrams of an example sequence for managing transfers between a first storage device and a second storage device, according to some embodiments.

FIG. 3D illustrates a method for managing transfers between a first storage device and a second storage device, according to some embodiments.

FIGS. 4A-4B illustrate conceptual diagrams of example approaches for managing storage space availability in a non-volatile memory of a storage device, according to some embodiments.

FIG. 4C illustrates a method for managing storage space availability in a storage device, according to some embodiments.

FIG. 5 illustrates a detailed view of a computing device that can be configured to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The described embodiments set forth techniques for managing solid-state storage devices (SSDs). In particular, the embodiments set forth techniques for mitigating write amplification in SSDs, managing data transfers between different types of SSDs (e.g., single-level cell (SLC) to triple-level cell (TLC) SSDs), and managing storage space availability in SSDs under load conditions.

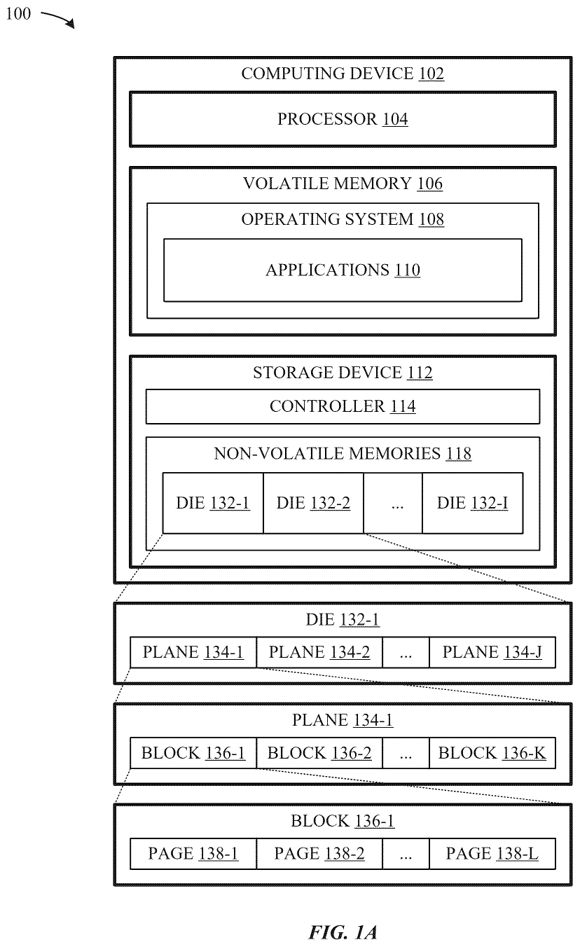

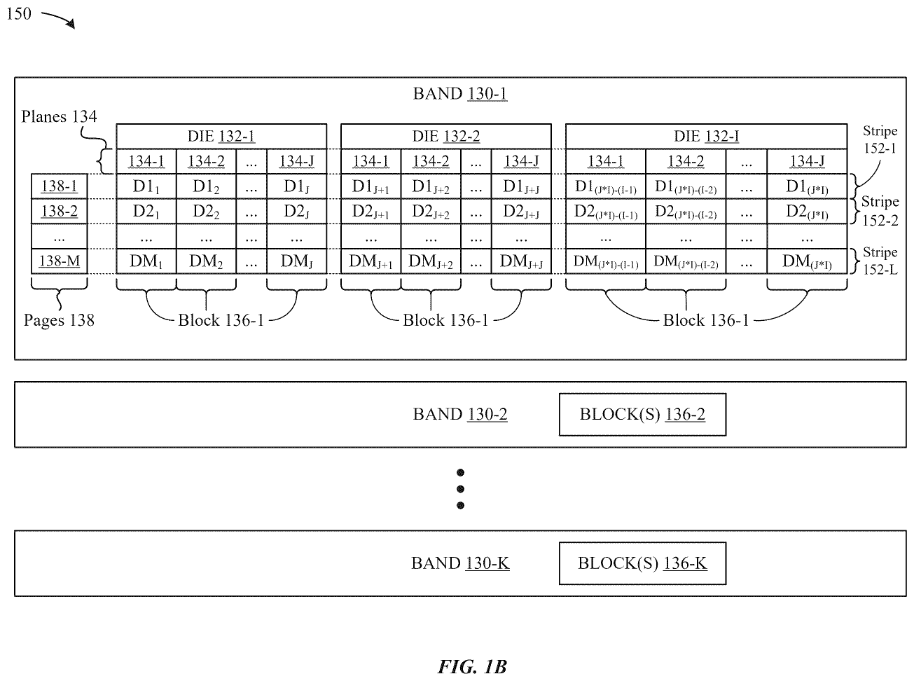

A more detailed discussion of these techniques is set forth below and described in conjunction with FIGS. 1A-1B, 2A-2F, 3A-3B, and 4, which illustrate detailed diagrams of systems and methods that can be configured to implement these techniques.

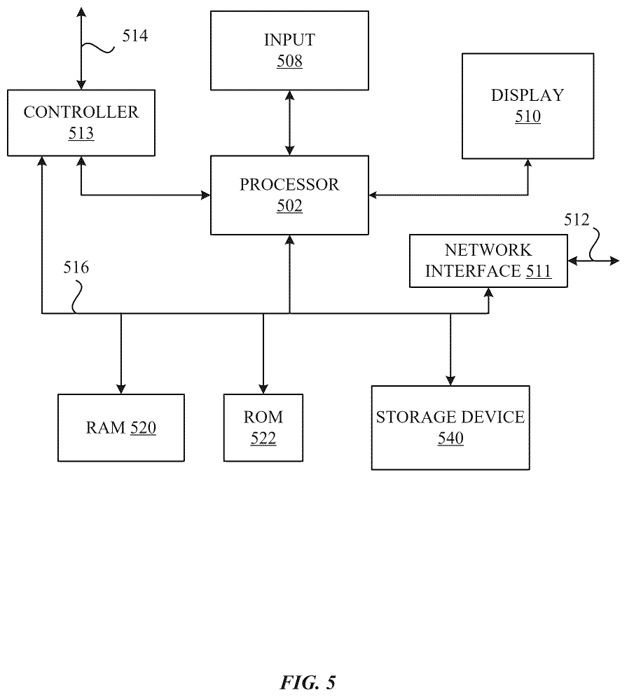

FIG. 1A illustrates a block diagram 100 of a computing device 102—e.g., a smart phone, a tablet, a laptop, a desktop, a server, etc.—that is configured implement the various techniques described herein. As shown in FIG. 1A, the computing device 102 can include a processor 104 that, in conjunction with a volatile memory 106 (e.g., a dynamic random-access memory (DRAM)) and a storage device 112 (e.g., a solid-state drive (SSD)), enables different software entities to execute on the computing device 102. For example, the processor 104 can be configured to load, from the storage device 112 into the volatile memory 106, various components for an operating system 108. In turn, the operating system 108 can enable the computing device 102 to provide a variety of useful functions, e.g., loading/executing various applications 110 (e.g., operating system daemons, user applications, etc.). According to some embodiments, the operating system 108/applications 110 can issue write commands to the storage device 112, e.g., new data writes, existing data overwrites, existing data migrations, and so on. It should be understood that the computing device 102 illustrated in FIG. 1A is presented at a high level in the interest of simplifying this disclosure, and that a more detailed breakdown is provided below in conjunction with FIG. 5.

According to some embodiments, and as shown in FIG. 1A, the storage device 112 can include a controller 114 that is configured to orchestrate the overall operation of the storage device 112. For example, the controller 114 can be configured to receive and process input/output (I/O) requests issued by the operating system 108/applications 110 to the storage device 112. It is noted that the controller 114 can include additional entities (not illustrated in FIG. 1A) that enable the implementation of the various techniques described herein. Is further noted that these entities can be combined or split into additional entities without departing from the scope of this disclosure. For example, the computing device 102 can be configured to perform all or some of the techniques described herein. It is additionally noted that the various entities described herein can be implemented using software-based or hardware-based approaches.

As shown in FIG. 1A, the storage device 112 can include any number of non-volatile memory 118 non-volatile memories 118. For example, under one approach, the storage device 112 can include a single-level cell (SLC) non-volatile memory 118 and a triple-level cell (TLC) non-volatile memory 118, where the SLC non-volatile memory 118 is utilized to store data that is frequently accessed by the computing device 102 and the TLC non-volatile memory 118 is utilized to store data that is infrequently accessed by the computing device 102. It is noted that the foregoing example is not meant to be limiting, and that the storage device 112 can include any amount, type, form, etc., of non-volatile memories 118, consistent with the scope of this disclosure.

According to some embodiments, and as shown in FIG. 1A, a given non-volatile memory 118 can be composed of a collection of dies 132, and each die 132 can include a variety of sub-components. In particular, each die 132 can include a collection of planes 134. Moreover, each plane 134 can include a collection of blocks 136. Further, each block 136 can include a collection of pages 138, where each page 138 is composed of a collection of sectors (not individually illustrated in FIG. 1A). In accordance with this breakdown, the various components of the non-volatile memory 118 can be logically separated into a collection of bands 130, which are described below in greater detail in conjunction with the conceptual diagram 150 illustrated in FIG. 1B.

According to some embodiments, one or more of the non-volatile memories 118 can store log information, indirection information, data information, and the like. According to some embodiments, transactional information associated with the indirection information/data information—e.g., details associated with I/O requests processed by the controller 114—can be written into the log information, such that replay operations can be performed to restore coherency when recovering from power failures. For example, the transactional information can be utilized to restore the content of the indirection information when an inadvertent shutdown of the computing device renders at least a portion of the content out-of-date. According to some embodiments, the content stored in the indirection information can include context information that serves as a mapping table for data that is stored within the data information. According to some embodiments, the context information can be transmitted between the volatile memory 106 and the non-volatile memory 118 using direct memory access (DMA) such that the processor 104 plays little or no role in the data transmissions between the volatile memory 106 and the non-volatile memory 118. It is noted, however, that any technique can be utilized to transmit data between the volatile memory 106 and the non-volatile memory 118 without departing from the scope of this disclosure.

FIG. 1B illustrates a conceptual diagram 150 of how different bands 130 can be established within a given non-volatile memory 118 to encompass a respective collection of blocks 136 of the non-volatile memory 118. In particular, FIG. 1B illustrates a fixed-with approach for organized bands 130 within the non-volatile memory 118, where each band 130 shares a same width that is sized in accordance with the total number of planes 134 included in the non-volatile memory 118.

As illustrated in FIG. 1B, each band 130 can logically span across the dies 132 of the non-volatile memory 118. In this regard, the overall “width” of a given band 130 can be defined by the number of dies 132 that the band 130 spans. Additionally, each band 130 can logically include a particular block 136 of each of the planes 134 of the dies 132 that are logically included in the band 130. For example, when a given band 130 is configured to span a total of three dies 132, and each die 132 includes three planes 134, (i.e., a total of nine planes 134), a first band 130-1 of the non-volatile memory 118 can logically include the first block 136-1 of all nine planes 134, a second band 130-2 of the non-volatile memory 118 can logically include the second block 136-2 of all nine planes 134, and so on. It is noted that the logical cutoffs relative to the components of the non-volatile memory 118 (i.e., the dies 132, the planes 134, the blocks 136, the pages 138, etc.) can be modified to control what is logically included in the bands 130. For example, one or more of the dies 132 can be reserved by the storage device 112—e.g., for overprovisioning-based techniques—without departing from the scope of this disclosure, such that a given band 130 logically includes only a subset of the dies 132 that are available within the non-volatile memory 118.

As illustrated in FIG. 1B, each band 130 can be separated into a collection of stripes 152, where each stripe 152 within the band 130 logically includes a particular page 138 across the blocks 136/planes 134 that are logically included in the band 130. In this regard, the overall “height” of a given band 130 can be defined by a number of stripes 152 that are logically included in the band 130. Accordingly, when a given band 130 spans three different dies 132, where each die 132 includes three planes 134, and where each plane 134 includes three blocks 136, a total of twenty-seven (27) pages 138 are included in the band 130. As described in greater detail herein, limiting a given band 130 to a particular number of stripes 152 can enable two or more bands 130 to be established relative to the non-volatile memory 118. In this regard, different bands 130 can established and utilized to implement different techniques. For example, a first collection of bands 130 can be utilized to store user data, a second collection of bands 130 can be utilized to store parity information (for redundancy techniques), a third collection of bands can be utilized to store log data, and so on. It is noted that the foregoing bands 130 are merely exemplary, and that any number of bands 130, for any purpose, can be implemented without departing from the scope of this disclosure. Additionally, it is noted that organization data that defines how the various bands 130 are configured can be stored within the log information, indirection information, etc., previously described herein.

As illustrated in FIG. 1B, data stored within a given band 130 can be disparately distributed across the non-volatile memory 118 as a consequence of the pages 138, blocks 136, planes 134, and dies 132 that are logically included the band 130. For example, in FIG. 1B, a first data component can be written across the pages 138:(D1₁-D1_{(J*I)}) of a first stripe 152-1 that spans the dies 132-I and the planes 134-J (of each die 132-I). Continuing with this example, a second data component can be written across the pages 138:(D2₁-D2_{(J*1)}) of a second stripe 152-2 that spans the dies 132-I and the planes 134-J (of each die 132-I). It is noted that the first data component and the second data component can be associated with the same or different data objects. For example, a data object having a size that exceeds what can be stored across the pages 138 of the first stripe 152-1 can wrap into the pages 138 of the second stripe 152-2 (and additional stripes 152, bands 130, etc., if necessary) until the data object is completely stored in the non-volatile memory 118.

It is noted that the breakdown of the non-volatile memory 118 illustrated in FIG. 1B is merely exemplary, and does not, in any manner, represent any limitations associated with the embodiments described herein. On the contrary, the non-volatile memory 118 can include any number of dies 132, planes 134, blocks 136, pages 138, bands 130, stripes 152, bands 130, stripes 152, etc., without departing from the scope of this disclosure.

As previously described herein, the bands 130 illustrated in FIG. 1B are configured using a fixed-width approach, where the width of each band 130 is the same and is sized to span the number of dies 132, planes 134, and so on. However, in some cases, it can be desirable to implement dynamic-width bands 130 (where the widths of different bands 130 can vary). In particular, storage devices 112 with relatively low storage capacity, when filled with data—e.g., to the extent that little free space is available—can experience considerable write amplification when attempting to accommodate new write operations, to perform garbage collection (i.e., data relocation) operations, and so on. In this regard, generating reduced-width bands 130 (e.g., relative to the maximum width allowed relative to the number of dies 132, planes 134, etc.) can effectively reduce the overall granularity by which bands 130 are managed within the storage device 112, which can help mitigate the aforementioned write amplification issues.

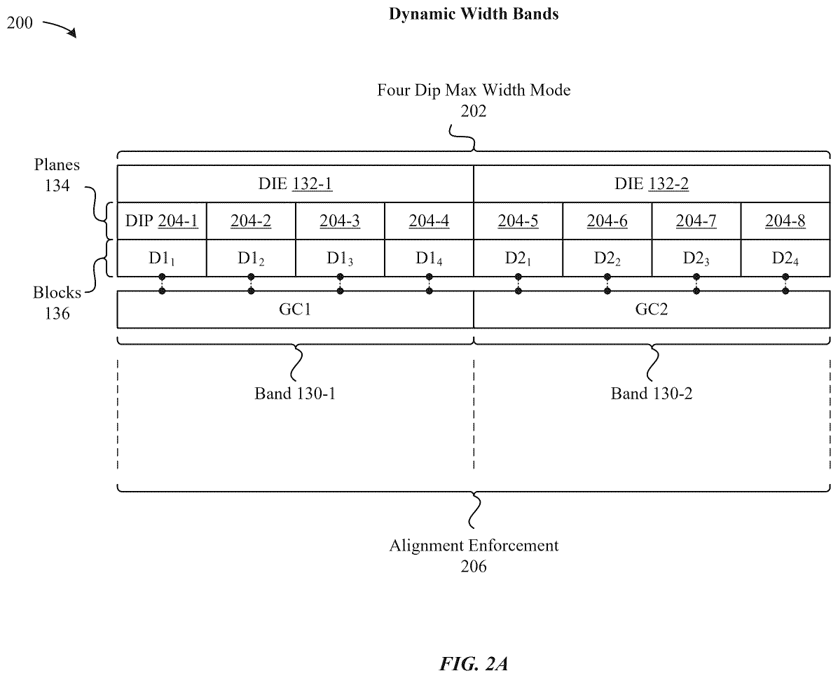

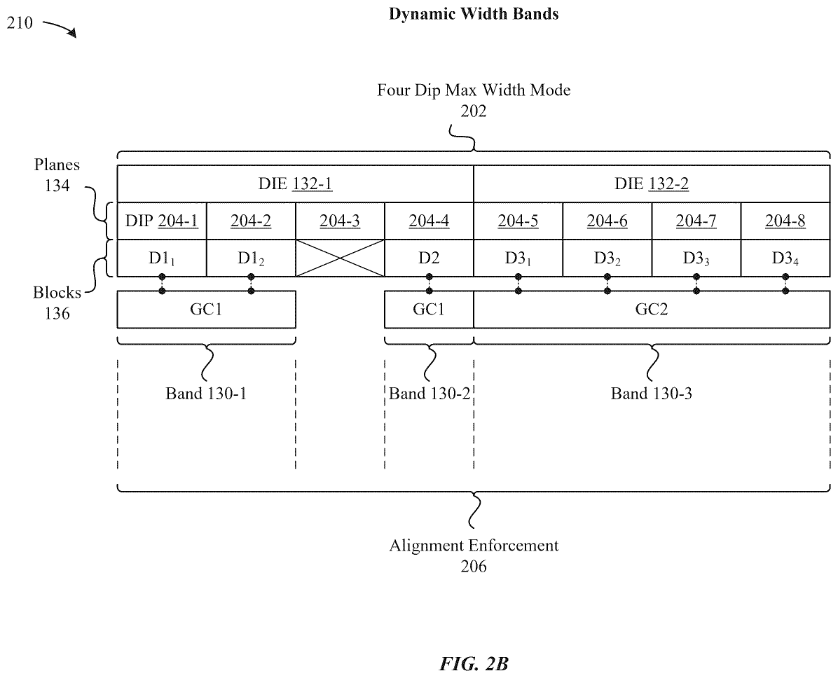

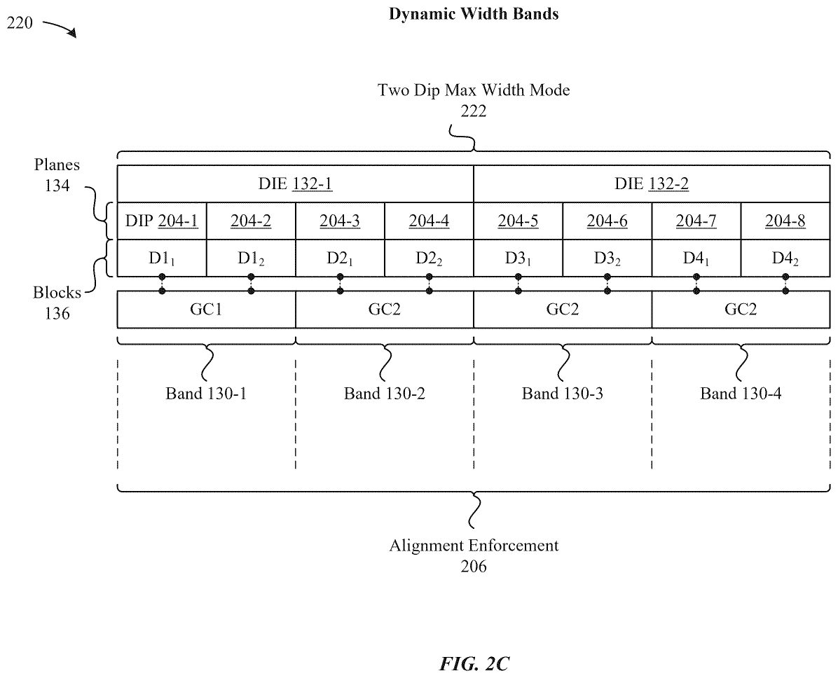

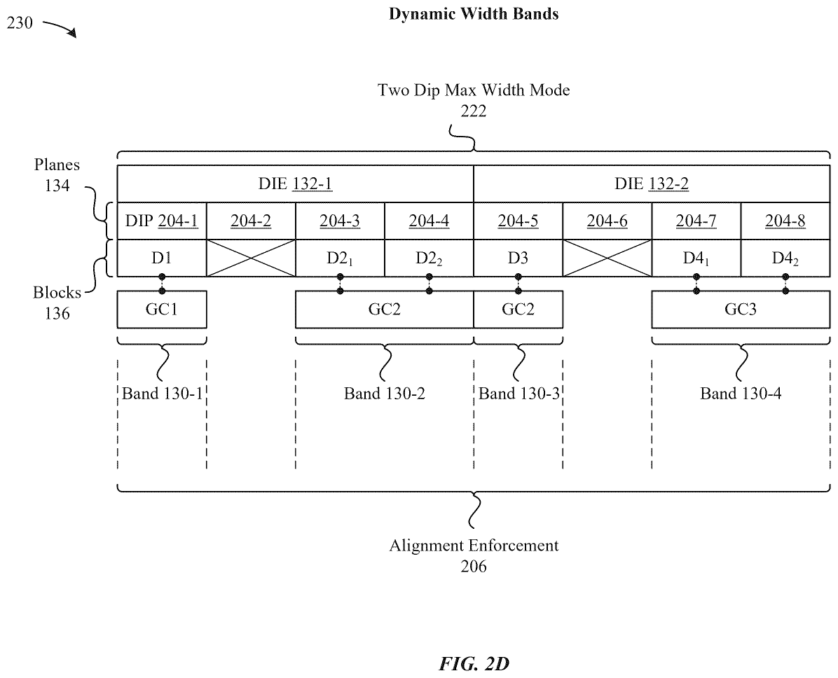

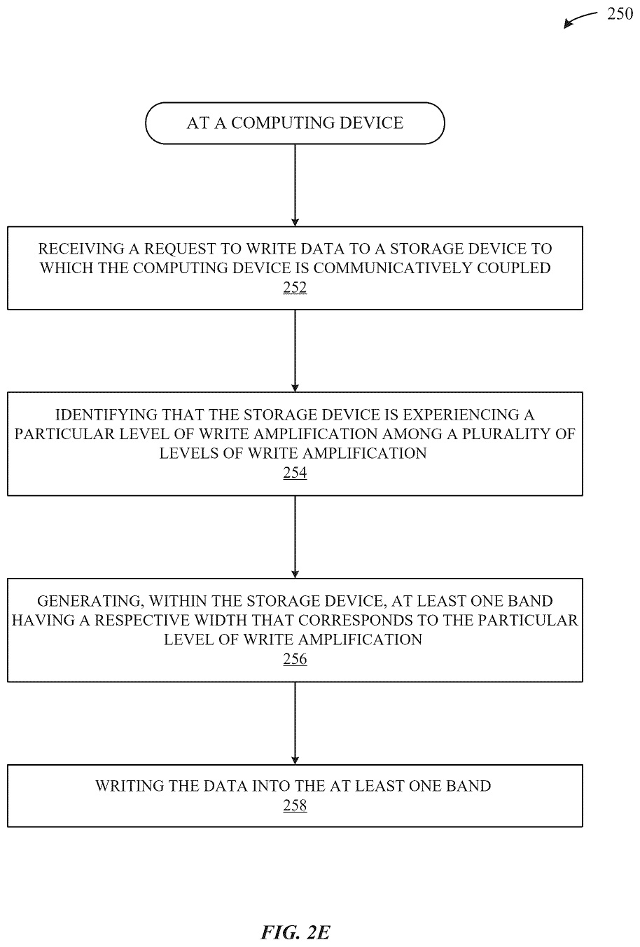

Accordingly, FIGS. 2A-2D illustrate conceptual diagrams of different approaches for managing dynamic-width bands 130, according to some embodiments. As a brief aside, and as shown in FIG. 2A, the term “dip” refers to a given plane 134 within a given die 132 of the storage device 112, such that each dip 204 corresponds to a unique plane 134. In this regard, if the storage device 112 includes two dies 132, and each die 132 includes four planes 134, then the storage device 112 effectively includes eight dips 204, where the first four dips 204 correspond to the four planes 134 in the first die 132, and the second four dips 204 correspond to the four planes 134 in the second die 132. As described in greater detail herein, the respective width of a given band can be sized in accordance with a total number of dips included in the storage device.

FIG. 2A illustrates a four-dip max width mode 202. Under this mode, each band 130 can be assigned a maximum width of four dips 204. Alternatively, each band 130 can be assigned a width that is less than four dips 204, so long as the width is equal to two to the power of zero or one (in other words, a smaller width of one or two dips 204). Accordingly, under the four-dip max width mode 202, each band 130 can have a width of one dip 204, two dips 204, or four dips 204. In the example scenario 200 illustrated in FIG. 2A, two bands 130 are established under the constraints of the four-dip max width mode 202: a first band 130-1 that logically includes four dips 204 (i.e., planes 134-1 through planes 134-4 of die 132-1), and a second band 130-2 that logically includes four dips 204 (i.e., planes 134-1 through planes 134-1 of die 132-2). As shown in FIG. 2A, the first band 130-1 stores data D1₁-D1₄, and the second band 130-2 stores data D2₁-D2₄.

Additionally, as shown in FIG. 2A, each band 130 can be associated with a garbage collection (GC) value where appropriate. For example, the value “GC1” can indicate that a given band 130 stores data that has been garbage collected (i.e., relocated with in the non-volatile memory 118) one time, the value “GC2” can indicate that a given band 130 stores data that has been garbage collected two times, the value “GC3” can indicate that a given band stores data that has been garbage collected three times, and so on. In this regard, when data stored in a band 130 is data that was written for a first time (i.e., independent from a garbage collection procedure), then the band 130 can be assigned another value. It is noted that the foregoing examples are not meant to be limiting, and that the foregoing designations can be assigned to the bands 130 using any amount, type, form, etc., of information, at any level of granularity, consistent with the scope of this disclosure.

Additionally, and as shown in FIG. 2A, alignment enforcement 206 can be implemented to improve the overall manner in which bands 130 are logically distributed within the non-volatile memory 118. In particular, alignment enforcement 206 can require that each band 130 starts at a dip 204 position that is the first dip 204, or is a dip 204 that is based on the width of the band 130. For example, a band 130 that is four dips wide can start at the first dip 204-1, the fifth dip 204-5, the ninth dip 204-9, and so on. In another example, a band 130 that is two dips wide can start at the first dip 204-1, the third dip 204-3, the fifth dip 204-5, the seventh dip 204-7, and so on. In yet another example, a band that is one dip wide can start at any of the dips 204.

FIG. 2B illustrates another example scenario 210 of the four-dip max width mode 202, where three bands 130 are established: a first band 130-1 that logically includes two dips 204 (i.e., plane 134-1 and plane 134-2 of die 132-1), a second band 130-2 that logically includes one dip 204 (i.e., plane 134-4 of die 132-1), and a third band 130-3 that logically includes four dips 204 (i.e., plane 134-5 through plane 134-8 of die 132-2). As shown in FIG. 2B, the first band 130-1 stores data D1₁-D1₂, the second band 130-2 stores data D2, and the third band 130-3 stores data D3₁-D3₄. Additionally, as shown in FIG. 2B, alignment enforcement 206 can be implemented across the bands 130 to improve the overall manner in which the bands 130 are logically distributed within the non-volatile memory 118.

Additionally, FIG. 2C illustrates a two-dip max width mode 222. Under this mode, each band 130 can be assigned a maximum width of two dips 204. Alternatively, each band can be assigned a width that is less than two dips (i.e., a smaller width of one dip 204). Accordingly, under the two-dip max width mode 222, each band 130 can have a width of one dip 204 or two dips 204. In the example scenario 220 illustrated in FIG. 2C, four bands 130 are established under the constraints of the two-dip max width mode 222: a first band 130-1 that logically includes two dips 204 (i.e., plane 134-1 and plane 134-2 of die 132-1), a second band 130-2 that logically includes two dips 204 (i.e., plane 134-3 and plane 134-4 of die 132-1), a third band 130-3 that logically includes two dips 204 (i.e., plane 134-5 and plane 134-6 of die 132-2), and a fourth band 130-4 that logically includes two dips 204 (i.e., plane 134-7 and plane 134-8 of die 132-2). As shown in FIG. 2C, the first band 130-1 stores data D1₁-D1₂, the second band 130-2 stores data D2₁-D2₂, the third band 130-3 stores data D3₁-D3₂, and the fourth band 130-4 stores data D4₁-D4₂. Additionally, and as shown in FIG. 2C, alignment enforcement 206 can be implemented to improve the overall manner in which bands 130 are logically distributed within the non-volatile memory 118.

FIG. 2D illustrates another example scenario 230 of the two-dip max width mode 222, where four bands 130 are established: a first band 130-1 that logically includes one dip 204 (i.e., plane 134-1 of die 132-1), a second band 130-2 that logically includes two dips 204 (i.e., plane 134-3 and plane 134-4), a third band 130-3 that logically includes one dip 204 (i.e., plane 134-5 of die 132-2), and a fourth band 130-4 that logically includes two dips (i.e., plane 134-7 and plane 134-8 of die 132-2). As shown in FIG. 2D, the first band 130-1 stores data D1, the second band 130-2 stores data D2₁-D2₂, and the third band 130-3 stores data D3, and the fourth band 130-4 stores data D4₁-D4₂. Additionally, as shown in FIG. 2D, alignment enforcement 206 can be implemented across the bands 130 to improve the overall manner in which the bands 130 are logically distributed within the non-volatile memory 118.

As a brief aside, it should be appreciated that other max dip-width modes can be implemented without departing from the scope of this disclosure. For example, under a configuration where a given non-volatile memory 118 includes a total of twelve dips 204 (e.g., three dies 132, where each die 132 includes four planes 134), the possible dip-widths for bands 130 can be one dip 204, two dips 204, four dips 204, or six dips 204. These dip-widths can be beneficial in that they can enable simultaneous interactions with all dips (or some subset thereof), e.g., two six-dip-wide bands 130, three four-dip-wide bands 130, some combination of one-dip-width, two-dip-width, four-dip-width, or six-dip-width bands 130, and so on. Additionally, it should be appreciated that the dips 204 of which a given band 130 is comprised do not necessarily need to be adjacent to one another (e.g., as illustrated in FIGS. 2A-2D). For example, under a configuration where a given non-volatile memory 118 includes a total of eight dips 204, a four-dip-width band 130 can correspond to the first, third, fifth, and seventh dip 204, or the second, fourth, sixth, and eighth dip 204. Again, it is noted that the foregoing examples are not meant to be limiting, and that the bands 130 can be sized, organized, distributed, etc., in accordance with any configuration of dies 132, planes 134, dips 204, etc., at any level of granularity, consistent with the scope of this disclosure.

Accordingly, FIGS. 2A-2D illustrate example scenarios under which different dip-width modes can be implemented within the storage device 112, according to some embodiments. Additional high-level details will now be provided below in conjunction with FIG. 2E, which illustrates a method 250 that can be implemented to carry out the techniques described above in conjunction with FIGS. 2A-2D, according to some embodiments.

FIG. 2E illustrates a method 250 for managing write amplification on a storage device, according to some embodiments. As shown in FIG. 2E, the method 250 begins at step 252, where the computing device 102 receives a request to write data to a storage device to which the computing device is communicatively coupled (e.g., as described above in conjunction with FIGS. 1A-1B and 2A-2D).

At step 254, the computing device 102 identifies that the storage device is experiencing a particular level of write amplification among a plurality of levels of write amplification (e.g., as described above in conjunction with FIGS. 1A-1B and 2A-2D).

At step 256, the computing device 102 generates, within the storage device, at least one band having a respective width that corresponds to the particular level of write amplification (e.g., as described above in conjunction with FIGS. 1A-1B and 2A-2D).

At step 258, the computing device 102 writes the data into the at least one band (e.g., as described above in conjunction with FIGS. 1A-1B and 2A-2D).

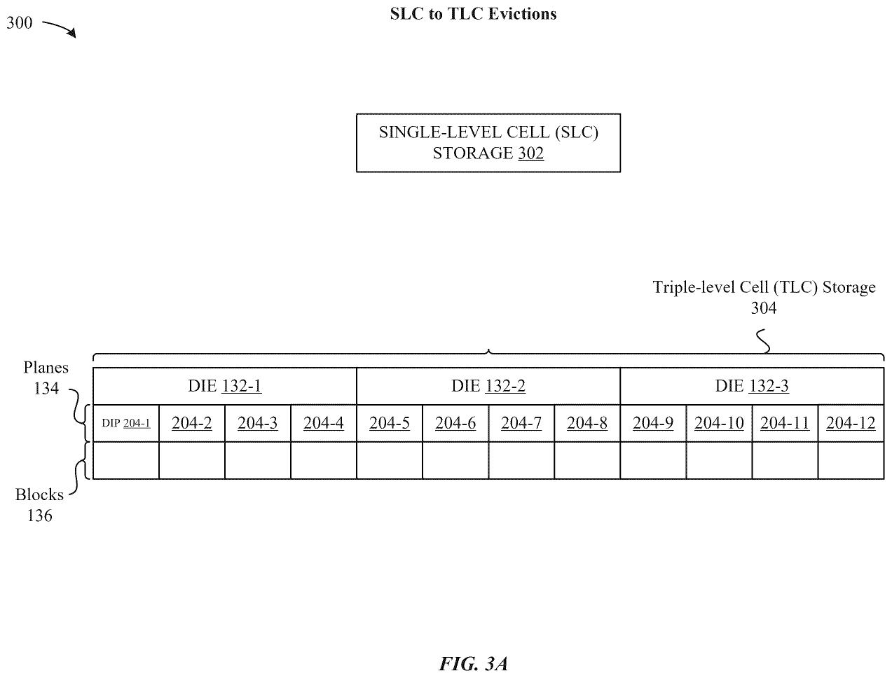

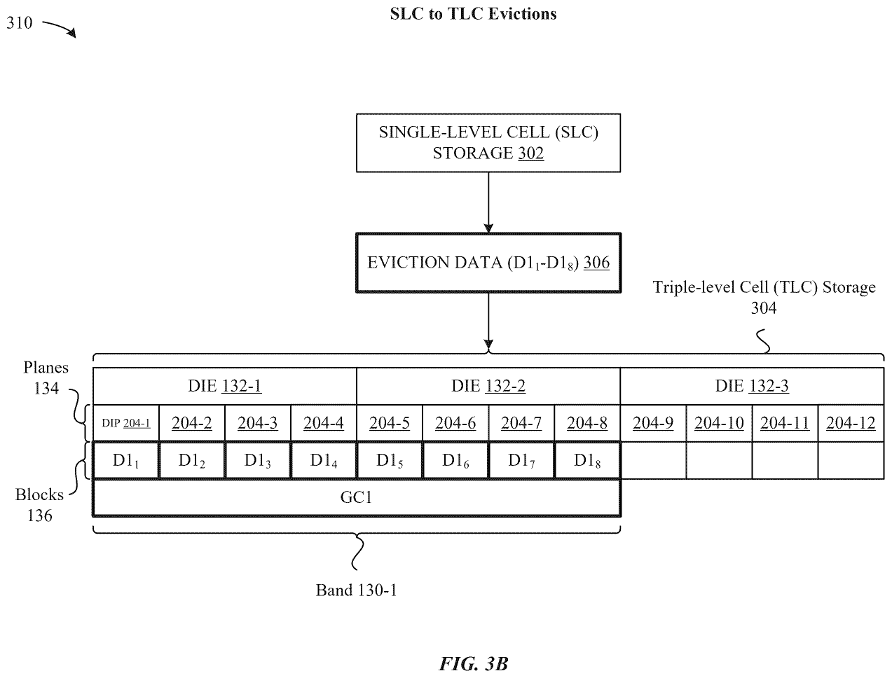

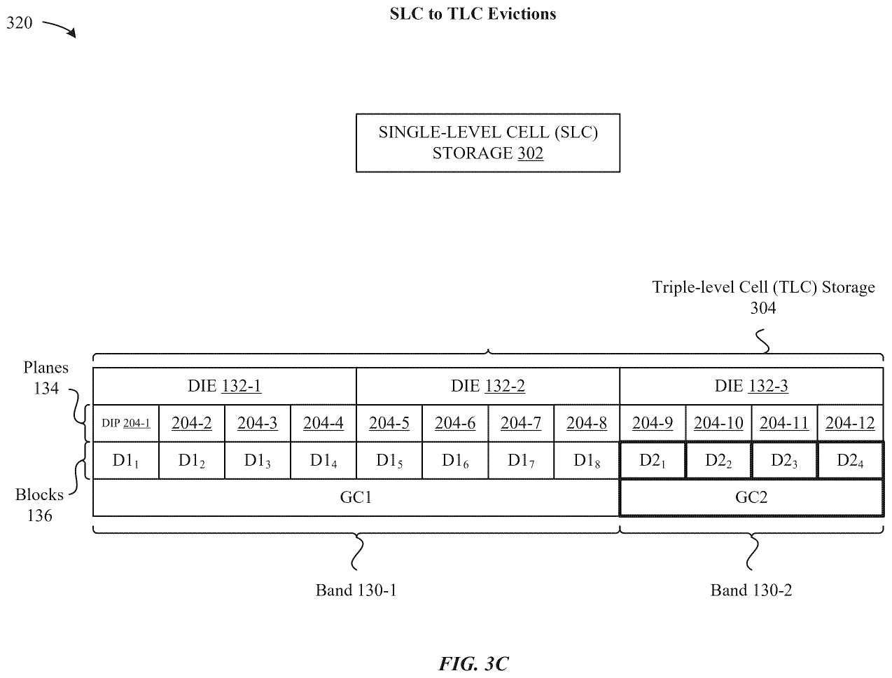

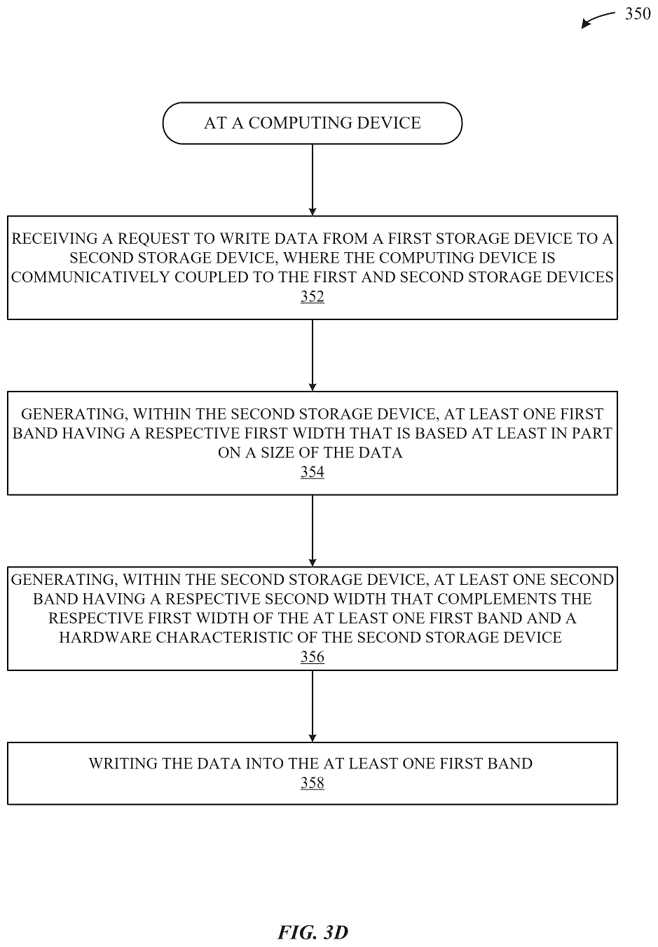

Additionally, FIGS. 3A-3C illustrate conceptual diagrams 300, 310, and 320 of an example sequence for managing transfers between a first storage device (e.g., a non-volatile memory 118-1) and a second storage device (non-volatile memory 118-2), according to some embodiments. As shown in FIG. 3A, the first storage device can be a single-level cell storage 302, and the second storage device can be a triple-level cell storage 304. In some cases, data written by the computing device 102 can be written to the single-level cell storage 302 instead of the triple-level cell storage 304, e.g., when the write operations need to be executed quickly, when the data will be frequently read/re-written, and so on. In this regard, conditions can arise where it can be beneficial for the aforementioned data to be relocated from the single-level cell storage 302 to the triple-level cell storage 304, e.g., after it is determined that the data is infrequently accessed, the data has grown in size, etc.

In any case, as shown in the conceptual diagram 310 FIG. 3A—and, in the interest of simplifying this disclosure—no bands 130 have been established within the triple-level cell storage 304. Turning now to the conceptual diagram 320 of FIG. 3B, an event occurs where it is necessary to transfer eviction data 306 from the single-level cell storage 302 to the triple-level cell storage 304. As shown in FIG. 3B, the eviction data 306 includes data D1₁-D1₈, which requires a band 130 having a width of eight dips 204 to accommodate the eviction data 306. Accordingly, the computing device 102/storage device 112/triple-level cell storage 304 generate a band 130-1 with a width of eight dips 204 (i.e., plane 134-1 through plane 134-8), and then distributes portions of the eviction data 306 (i.e., D1₁-D1₈) across the planes 134 (specifically, a respective block 136 within each of the planes 134). Additionally, the band 130-1 is designated as “GC1” to indicate that the data stored in the band 130-1 has been relocated one time (i.e., from single-level cell storage 302 to triple-level cell storage 304).

Additionally, it can be beneficial to concurrently generate a band 130 that acquires a remainder of available dips 204 (if any) relative to the band 130-1, which can enable garbage collection operations to be more efficiently performed within the triple-level cell storage 304. Accordingly, in the example illustrated in FIG. 3C, computing device 102/storage device 112/triple-level cell storage 304 also generates a band 130-2 having a width of eight dips 204 (i.e., planes 134-9 through planes 134-12). The band 130-2 is also designated as “GC2” to indicate that data stored in the band 130-2 has been relocated twice (the details of which are not illustrated in FIG. 3C).

Accordingly, FIGS. 3A-3C illustrate an example sequence of managing a transfer of data between a first storage device (e.g., a non-volatile memory 118-1) and a second storage device (non-volatile memory 118-2), according to some embodiments. Additional high-level details will now be provided below in conjunction with FIG. 3D, which illustrates a method 350 that can be implemented to carry out the techniques described above in conjunction with FIGS. 3A-3C, according to some embodiments.

FIG. 3D illustrates a method 350 for managing transfers between a first storage device and a second storage device, according to some embodiments. As shown in FIG. 3, the method 350 begins at step 352, where the computing device 102 receives a request to write data from a first storage device to a second storage device, where the computing device is communicatively coupled to the first and second storage devices (e.g., as described above in conjunction with FIGS. 1A-1B and 3A-3C).

At step 354, the computing device 102 generates, within the second storage device, at least one first band having a respective first width that is based at least in part on a size of the data (e.g., as described above in conjunction with FIGS. 1A-1B and 3A-3C).

At step 356, the computing device 102 generates, within the second storage device, at least one second band having a respective second width that complements the respective first width of the at least one first band and a hardware characteristic of the second storage device (e.g., as described above in conjunction with FIGS. 1A-1B and 3A-3C).

At step 358, the computing device 102 writings the data into the at least one first band (e.g., as described above in conjunction with FIGS. 1A-1B and 3A-3C).

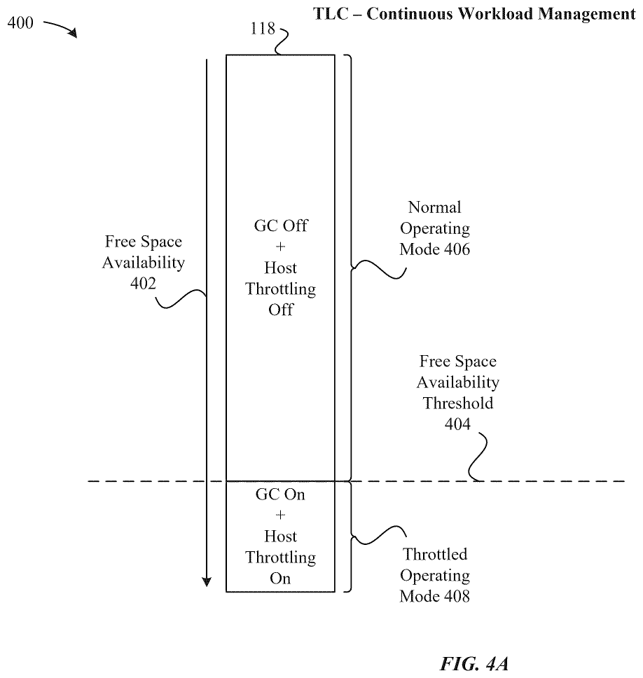

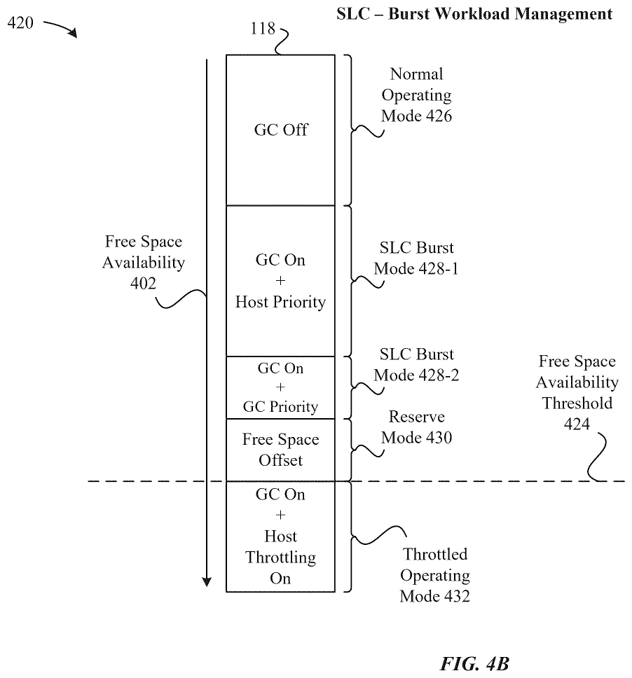

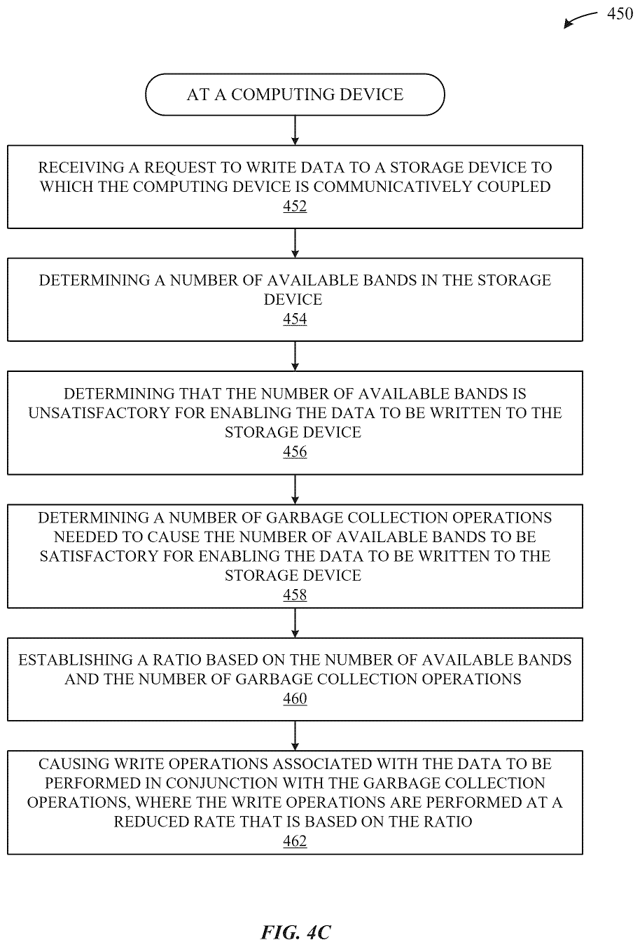

FIGS. 4A-4B illustrate conceptual diagrams of example approaches for managing storage space availability in a non-volatile memory 118 of a storage device 112, according to some embodiments. In particular, FIG. 4A illustrates a first approach 400 for managing continuous workloads under situations where free available storage space in the non-volatile memory 118 falls below a particular threshold. As shown in FIG. 4A, when free space availability 402 remains above a free space availability threshold 404 (e.g., is greater than, greater than or equal to, etc.), both garbage collection operations and host throttling can be deactivated (illustrated in FIG. 4A as normal operating mode 406). However, when free space availability 402 satisfies (e.g., is less than, less than or equal to, etc.) the free space availability threshold 404, then garbage collection operations and host throttling can be activated (illustrated in FIG. 4A as throttled operating mode 408).

Consider an example scenario in which a request to write data is received, where twenty (free) bands 130 within the non-volatile memory 118 are needed to accommodate the data, ten bands 130 are available within the non-volatile memory 118, and the free space availability threshold is set to five bands 130. In this example, a portion of the data can be written into five of the ten bands 130 that are available within the non-volatile memory 118. After the aforementioned portion of data is written, only five bands 130 remain available within the non-volatile memory 118, at which point the free space availability threshold 404 will be triggered.

When the trigger occurs, the storage device 112 can identify a number of garbage collection operations that are needed to effectively produce the number of bands 130 that are still needed to write the remainder of the data—i.e., fifteen bands 130. The storage device 112 can also identify a number of available bands band 130 in the non-volatile memory 118 (e.g., five bands 130). In turn, the storage device 112 can calculate a ratio of the number of available bands relative to the number of garbage collection operations (e.g., 5/15=⅔). The ratio can then be used as a throttle rate to effectively slow down the manner in which the computing device 102 performs the write operations associated with the remainder of the data. In this manner, the storage device 112 can more effectively perform the garbage collection operations to free up bands 130 within the non-volatile memory 118 (while periodically accommodating write operations from the computing device 102). This approach beneficially helps avoid deadlock situations where the computing device 102 completely stalls and is unable to write any data to the non-volatile memory 118 until garbage collection operations are concluded and the requisite free space has been established.

It is noted that the foregoing examples, thresholds, etc., are not meant to be limiting, and that any number of thresholds, operating modes, etc., can be implemented, based on any amount, type, form, etc., of information, at any level of granularity, consistent with the scope of this disclosure. For example, FIG. 4B illustrates a second approach 420 that involves implementing additional thresholds (i.e., increased granularity), which can be beneficial when handling bursty workloads that frequently and periodically stress the storage device 112. For example, as shown in FIG. 4B, a normal operating mode 426 can be implemented (where garbage collection is inactive), an SLC burst mode 428-1 can be implemented (where garbage collection is active, but the host has priority over garbage collection), an SLC burst mode 428-2 (where garbage collection is active and has priority over the host), a reserve mode 430, and a throttled operating mode 432 (e.g., akin to the throttled operating mode 408 described above).

Again, it should be understood that any number of thresholds, operating conditions, etc., can be implemented to effectively determine when the different modes should be activated, e.g., the amount of available storage space in the non-volatile memory 118, the manner in which write operations are being issued to the non-volatile memory 118 (e.g., types, rates, data sizes, etc.), and so on. Again, these examples are not meant to be limiting, and it should be understood that any amount, type, form, etc., of information, at any level of granularity, can be used to effectively identify how and when the different modes illustrated in FIGS. 4A-4B should be activated.

Accordingly, FIGS. 4A-4B illustrate conceptual diagrams of example approaches for managing storage space availability in a non-volatile memory 118 of a storage device 112, according to some embodiments. Additional high-level details will now be provided below in conjunction with FIG. 4C, which illustrates a method 450 that can be implemented to carry out the techniques described above in conjunction with FIGS. 4A-4B, according to some embodiments.

FIG. 4C illustrates a method 450 for managing storage space availability in a storage device, according to some embodiments. As shown in FIG. 4, the method 450 begins at step 452, where the computing device 102 receives a request to write data to a storage device to which the computing device is communicatively coupled (e.g., as described above in conjunction with FIGS. 1A-1B and 4A-4B).

At step 454, the computing device 102 determines a number of available bands in the storage device (e.g., as described above in conjunction with FIGS. 1A-1B and 4A-4B). At step 456, the computing device 102 determines that the number of available bands is unsatisfactory for enabling the data to be written to the storage device (e.g., as described above in conjunction with FIGS. 1A-1B and 4A-4B). At step 458, the computing device 102 determines a number of garbage collection operations needed to cause the number of available bands to be satisfactory for enabling the data to be written to the storage device (e.g., as described above in conjunction with FIGS. 1A-1B and 4A-4B).

At step 460, the computing device 102 establishes a ratio based on the number of available bands and the number of garbage collection operations (e.g., as described above in conjunction with FIGS. 1A-1B and 4A-4B).

At step 462, the computing device 102 causes write operations associated with the data to be performed in conjunction with the garbage collection operations, where the write operations are performed at a reduced rate that is based on the ratio (e.g., as described above in conjunction with FIGS. 1A-1B and 4A-4B).

It is noted that this disclosure primarily involves the controller 114 carrying out the various techniques described herein for the purpose of unified language and simplification. However, it is noted that other entities can be configured to carry out these techniques without departing from this disclosure. For example, other software components (e.g., the operating system, applications, firmware(s), etc.) executing on the computing device 102/storage device 112 can be configured to carry out all or a portion of the techniques described herein without departing from the scope of this disclosure. Moreover, other hardware components included in the computing device 102/storage device 112 can be configured to carry out all or a portion of the techniques described herein without departing from the scope of this disclosure. Further, all or a portion of the techniques described herein can be offloaded to one or more other computing devices without departing from the scope of this disclosure.

FIG. 5 illustrates a detailed view of a computing device 500 that can represent the computing device 102 of FIG. 1A, according to some embodiments. As shown in FIG. 5, the computing device 500 can include a processor 502 that represents a microprocessor or controller for controlling the overall operation of the computing device 500. The computing device 500 can also include a user input device 508 that allows a user of the computing device 500 to interact with the computing device 500. For example, the user input device 508 can take a variety of forms, such as a button, keypad, dial, touch screen, audio input interface, visual/image capture input interface, input in the form of sensor data, and so on. Still further, the computing device 500 can include a display 510 that can be controlled by the processor 502 (e.g., via a graphics component) to display information to the user. A data bus 516 can facilitate data transfer between at least a storage device 540, the processor 502, and a controller 513. The controller 513 can be used to interface with and control different equipment through an equipment control bus 514. The computing device 500 can also include a network/bus interface 511 that couples to a data link 512. In the case of a wireless connection, the network/bus interface 511 can include a wireless transceiver.

As noted above, the computing device 500 also includes the storage device 540, which can comprise a single disk or a collection of disks (e.g., hard drives). In some embodiments, storage device 540 can include flash memory, semiconductor (solid state) memory or the like. The computing device 500 can also include a Random-Access Memory (RAM) 520 and a Read-Only Memory (ROM) 522. The ROM 522 can store programs, utilities or processes to be executed in a non-volatile manner. The RAM 520 can provide volatile data storage, and stores instructions related to the operation of applications executing on the computing device 500.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for managing write amplification on a storage device, the method comprising, by a computing device that is communicatively coupled to the storage device:
receiving a request to write data to the storage device;
identifying that the storage device is experiencing a particular level of write amplification among a plurality of levels of write amplification;
generating, within the storage device, at least one band having a respective width that corresponds to the particular level of write amplification; and
writing the data into the at least one band.

2. The method of claim 1, wherein the data is not stored on the storage device and the request is to write the data to a location on the storage device, or wherein the data is already stored at a first location of the storage device, and the request is to relocate the data to a second location on the storage device.

3. The method of claim 2, wherein, when the data is already stored at the first location, the method includes assigning a property to the at least one band, wherein the property indicates a respective number of times that the data stored within the at least one band has been relocated within the storage device by way of garbage collection activities.

4. The method of claim 1, wherein the storage device includes a plurality of dies that include a given die that includes a plurality of planes, wherein a given plane of the plurality of planes includes a plurality of blocks that include a particular block that includes a plurality of pages.

5. The method of claim 4, wherein the at least one band logically includes one or more blocks of the storage device, and wherein a given plurality of blocks is included in a different respective plane of the respective plurality of planes, wherein the different respective plane is included in a corresponding die of the plurality of dies of the storage device.

6. The method of claim 5, wherein the given plurality of blocks corresponds respective dip numbers of a plurality of dip numbers associated with the storage device, and wherein a respective dip number that corresponds to a first block of the given plurality of blocks is a starting dip number of the plurality of dip numbers, or divisible by the respective width of the at least one band without producing a remainder.

7. The method of claim 1, wherein the respective width of the at least one band is sized in accordance with a total number of dips included in the storage device.

8. The method of claim 1, wherein the particular level of write amplification is determined based on the request to write the data, and other data that was previously written to the storage device.

9. A method for managing transfers between a first storage device and a second storage device, the method comprising, by a computing device that is communicatively coupled to the first and second storage devices:
receiving a request to write data from the first storage device to the second storage device;
generating, within the second storage device, at least one first band having a respective first width that is based at least in part on a size of the data;
generating, within the second storage device, at least one second band having a respective second width that complements the respective first width of the at least one first band and a hardware characteristic of the second storage device; and
writing the data into the at least one first band.

10. The method of claim 9, wherein the first storage device comprises a single-level cell (SLC) storage device, and wherein the second storage device comprises a triple-level sell (TLC) storage device.

11. The method of claim 9, further comprising:
assigning a first property to the at least one first band, wherein the first property indicates a first number of times that data stored within the at least one first band has been relocated by way of garbage collection activities; and
assigning a second property to the at least one second band, wherein the second property indicates a second number of times that data stored within the at least one second band has been relocated as a result of the garbage collection activities.

12. The method of claim 9, wherein the second storage device includes a plurality of dies that include respective plurality of planes, and wherein a given plurality of planes of the respective plurality of planes includes a plurality of blocks that include respective pluralities of pages.

13. The method of claim 12, wherein:
the at least one first band logically includes one or more first blocks of the second storage device, and each first block of the one or more first blocks is included in a different respective plane of the respective plurality of planes, wherein the different respective plane is included in a respective die of the plurality of dies of the second storage device; and
the at least one second band logically includes one or more second blocks of the second storage device that complement the one or more first blocks of the at least one first band, wherein each second block of the one or more second blocks is included in a corresponding respective plane of the respective plurality of planes, and the corresponding respective plane is included in a corresponding die of the plurality of dies of the second storage device.

14. The method of claim 13, wherein respective first blocks of the one or more first blocks corresponds to a respective dip number of a first plurality of dip numbers associated with the second storage device, wherein respective second blocks of the one or more second blocks corresponds to a respective dip number of a second plurality of dip numbers associated with the second storage device, wherein the respective dip number that corresponds to a first respective first block of the one or more first blocks or a second respective first block of the one or more second blocks is a starting dip number of the first or second plurality of dip numbers, respectively, or divisible by the respective first width or second width, respectively, of the at least one first band or the at least one second band, respectively, without producing a remainder.

15. The method of claim 14, wherein the respective first width of the at least one first band is sized in accordance with a total number of dips included in the storage device.

16. A method for managing storage space availability in a storage device, the method comprising, by a computing device that is communicatively coupled to the storage device:
receiving a request to write data to the storage device;
determining a number of available bands in the storage device;
determining that the number of available bands is unsatisfactory for enabling the write data to be written to the storage device;
determining a number of a plurality of garbage collection operations needed to cause the number of available bands to be satisfactory for enabling the write data to be written to the storage device;
establishing a ratio based on the number of available bands and the number of the plurality of garbage collection operations; and
causing write operations associated with the write data to be performed in conjunction with the plurality of garbage collection operations, wherein the write operations are performed at a reduced rate that is based on the ratio.

17. The method of claim 16, wherein the reduced rate is less than a normal rate at which write operations are typically performed by the computing device when a sufficient number of bands are available for writing given data to the storage device.

18. The method of claim 17, further comprising:
determining, subsequent to performing the garbage collection operations, that the number of available bands is satisfactory for enabling second data to be written to the storage device; and
causing second write operations associated with second data to be performed at the normal rate.

19. The method of claim 16, wherein the storage device includes a plurality of dies that include a given die that includes a plurality of planes, wherein a given plane of the plurality of planes includes a plurality of blocks that include a given block that includes a plurality of pages.

20. The method of claim 19, wherein a given band logically includes one or more blocks of the storage device, and wherein a particular block of the one or more blocks is included in a respective plane of the respective plurality of planes, wherein the respective plane is included in a corresponding die of the plurality of dies of the storage device.
